(19) United States
(12) Patent Application Publication
(10) Pub. No.: US 2008/0226905 A1
(43) Pub. Date: Sep. 18, 2008

(54) Method for Producing Low Anisotropy Pressure-Sensitive Adhesives

(75) Inventors: Thilo Dollase, Hamburg (DE); Bernd Dietz, Ammersbek (DE); Klaus Keite-Telgenbuscher, Hamburg (DE)

Correspondence Address: NORRIS, MCLAUGHLIN & MARCUS, 875 THIRD AVE, 18TH FLOOR, NEW YORK, NY, 10022, US

(73) Assignee: TESA AG, Hamburg (DE)

(21) Appl. No.: 12/090,896

(22) PCT Filed: Nov. 1, 2006
(86) PCT No.: PCT/EP2006/068016

§ 371 Date: May 29, 2008

(30) Foreign Application Priority Data
Nov. 10, 2005 (DE) 10 2005 054054.6

(51) Int. Cl. B05D 5/10; B32B 7/12

(52) U.S. Cl. 428/343; 427/208.4

(57) ABSTRACT

The invention relates to a method for producing pressure-sensitive adhesives that have low or no anisotropy, the process elements including an adhesive supply system, an application unit and a placement element. A melt strip of the pressure-sensitive adhesive is produced between the outlet of the application unit and the point of placement on the placement element and is stretched. The invention is characterized by controlling the stretching of the pressure-sensitive adhesive in the free melt strip by adjusting an effective ration G which is defined as the ratio of the effective time Δt of the stretching to the stretching rate R, and which is adjust to a value of not more that 0.008 s². The effective time Δt is defined by the formula 2 Lr/[vₛₜᵣᵢₚ (1+r)] wherein L is the length of the melt strip, r is the stretching ratio and vₛₜᵣᵢₚ is the speed of the melt strip and the stretching rate R is defined as a temporal derivative of the stretching ratio r.

The present invention relates to a method for producing pressure-sensitive adhesives (PSAs) of low or no anisotropy, comprising an adhesive supply system, suitable applicator mechanisms, and suitable placement elements, there being formed, during the operation, a free melt web of the PSA, which undergoes a draw operation. In accordance with the invention the draw operation on the free melt web is controlled via an activity ratio Γ which is characterized by the activity time in the draw operation, Δt, to the draw rate R. The invention further relates to the use of these PSAs in pressure-sensitively adhesive products.

By virtue of their permanent tack, pressure-sensitively adhesive products find diverse fields of use such as, for example, in the processing industry and in private households. Depending on application there are different requirements concerning the combination of adhesive and cohesive properties of the PSA. The required profile of properties of a PSA, and hence its usefulness for one or more applications, can be controlled typically through the selection of the base materials and their formulation. Important constituents in a PSA formula are polymers of sufficiently low softening temperature and high molar mass, which give the PSA a suitable viscoelastic character. Examples that may be mentioned at this point include rubbers and polyacrylates. Moreover, the properties of PSAs can be varied through the setting of the state of crosslinking. This gives rise to diverse possibilities for making PSAs available for numerous such different requirements. A range of different pressure-sensitively adhesive products is offered, some of which can be used universally for many different applications and some of which are tailored to specific applications.

Besides the influence of the base materials, however, the processing of the PSA may also affect the subsequent properties in the pressure-sensitively adhesive product. The reason for this is that the structure of the base materials in the coated PSA film may be different from one operation to the next or may differ according to the operational regime. This is a result of the flow profiles characteristic of a given processing operation, which can lead to deformation and orientation of constituents in the formulation that can be influenced in these respects, such as, more particularly, polymer chains, by shearing and/or extension [M. Pahl, W. Gleiβle, H. -M. Laun, Praktische Rheologie der Kunststoffe und Elastomere, 4th ed., 1995, VDI-Verlag, Düsseldorf, p. 337 et seq.]. One result of such deformation is the formation of oriented polymer chains [I.M. Ward in Structure and Properties of Oriented Polymers, I.M. Ward (ed.), 2^{nd} ed., 1997, Chapman & Hall, London]. The oriented state is associated with a structural anisotropy. By anisotropy is meant the circumstance that the value of a physical property of a medium has different values depending on the direction in which it is considered, and is not—as in the case of isotropy—the same when considered in every spatial direction.

Within an arbitrary processing operation the PSA system for processing is typically subject to laminar flow. Depending on the throughput and geometry of the space occupied by the PSA system or available to the PSA system, flow profiles arise which are based, to different extents, on shearing flows and/or extensional flows. The character of a shearing flow always prevails, ideally, when the external confines on the flow of the PSA, in other words, for example, the channel walls, during transport of the adhesive do not change over a path length under consideration. Tube flow may be one example of this ideal case. Extensional flow, in contrast, occurs whenever the flow confines converge or diverge. This is the case, for example, for all kinds of tapering of the adhesive's flow. Pure shearing flow and pure extensional flow, however, seldom prevail in actual operations. Instead, for the majority of the operating segments in an actual PSA coating operation, it is necessary to assume a superposition of shearing flow and extensional flow.

The production of pressure-sensitively adhesive products always includes a coating step in which the fluid PSA in the form, for example, of its melt or the solution or dispersion thereof is converted into a two-dimensional form. In the course of this processing step, shearing and/or extending influencing factors on the fluid under operation are manifested in a particularly pronounced way. In conventional methods, PSA solutions, for example, are applied by roll processes or blade processes to a continuously conveyed carrier material. In that case the solvent acts as an operating aid which sets the flow properties, i.e. the viscosity, but also the elasticity, of the material being processed, in such a way that coating results in a PSA layer of high surface quality. For reasons of cost and an increased environmental awareness, there is a trend toward reducing or eliminating entirely the volume of solvent used in the processing operation. In the past, therefore, coating processes have been developed in which it is possible to do without solvent—in some cases entirely. Technologies of this kind include hotmelt operations and extrusion operations in which the PSAs are processed from the melt. The high molecular mass polymer constituents in the PSA formulations for processing present particularly exacting requirements on these processes, owing to their property of exhibiting high melt viscosities. Examples of coating processes which are described for solvent-free coatings are disclosed in U.S. Pat. No. 3,783,072 by Johnson & Johnson, in DE 199 05 935 by Beiersdorf, and in U.S. Pat. No. 6,455,152 and EP 622 127 by 3M.

Such operations often involve melt webs, in other words free PSA films which are located between the exit slot of the applicator mechanism and the point of placement of a deposition element. It is known that, in melt webs of this kind, anisotropy is generated in the form of chain stretching and molecular orientation of polymeric constituents of a formulation. This is the case more particularly when a draw operation takes place within the melt web. Draw operations occur whenever the web velocity is higher than the adhesive exit velocity. A procedure of this kind is appropriate if the desired layer thickness in the coated web is to be lower than the exit slot of the applicator mechanism itself. Some of its advantages are that lower requirements are imposed on the precision of the applicator mechanism; the adjustability and regulability of the applicator mechanism become more practicable; and the pressure drop is reduced. This leads to tools of simpler construction, lighter weight, and more favorable cost, and also to reduced coating tolerances, and hence also often to an increase in quality for the products being produced. Film and fiber production operations utilize drawing purposively in order to generate orientation and hence to optimize certain mechanical properties such as the tensile strength, for example. On this point see, for example, J. L. White, M. Cakmak, “Orientation Processes” in Encyclopedia of Polymer Science and Engineering, volume 10, H. F. Mark, N. M. Bikales, C. G. Overberger, G. Menges, J. I. Kroschwitz (ed.), 2^{nd} ed., 1985, Wiley, New York.

Many high-value applications use polyacrylate-based PSAs. In contrast to many other elastomers, polyacrylates offer the advantage that they can be flexibly adapted to a required profile of properties through free-radical addition polymerization and through the use of different comonomers. They are distinguished, moreover, by good resistance to various external influences. For polyacrylate-based PSAs as well, recent years have seen a trend toward solvent-free coating processes and toward PSA systems which can be coated solventlessly. Examples of these are described in U.S. Pat. No. 5,391,406 by National Starch, in EP 377 199 by BASF, in WO 93/09152 by Avery Dennison, in DE 39 42 232 and DE 195 24 250 by Beiersdorf, and in DE 101 57 154 by tesa AG.

In principle, all formulations which contain long-chain polymers have the potential to form anisotropic structures. Such structures may be generated by deformation, leading to chain stretching and molecular orientation. The existence of anisotropy in pressure-sensitively adhesive products, however, is not always desirable, since it is associated with a potential for contraction, which in certain cases—especially in the case of carrier-less PSA films—can prove undesirable.

It is an object of the invention, therefore, to provide methods which allow PSAs to be provided—preferably solventlessly—in such a way as to provide access to pressure-sensitively adhesive products having a high performance profile but only low or no anisotropy.

It has surprisingly been found that this object can be achieved if the methods for producing PSAs are controlled in the orienting operation by an advantageously set defined ratio Γ which is characterized by activity time Δt to the draw rate R in the melt web. In order to obtain PSAs of minimum anisotropy, methods of the invention are designed in such a way that the combination of shearing and extending influences by process elements employed in the production operation is reduced.

The method of the invention for producing PSAs with low or no anisotropy comprises an adhesive supply system involving supply of the individual components of a pressure-sensitive adhesive system, including mixing and conveying assemblies, suitable applicator mechanisms, and placement elements. In accordance with the invention it is possible, for the production of PSAs, to employ any processing operations that produce a free melt web (a melt film). Preference is given to employing the solvent-free melt-mixing and coating of a carrier material. The free melt web is formed between the exit from the applicator mechanism and the point of placement on the deposition element, where it generally undergoes a draw operation. In accordance with the invention the method is characterized in that the draw operation on the free melt web is selectively influenced via the activity ratio Γ which is characterized by the activity time in the draw operation, Δt, relative to the draw rate R; in this way the production of PSAs is controlled.

The activity time Δt is defined by the formula 2 Lr/[v_{web} (1+r)], in which L is the length of the melt film, r is the draw ratio, and v_{web} is the velocity of the melt film. The draw rate R is defined as the time derivation of the draw ratio r. The individual components will be addressed in more detail later on below.

The method for producing low- or no-anisotropy PSAs is carried out by choosing the parameters for the inventive activity ratio Γ in such a way that it does not exceed a maximum value of 0.008 s²; the value ought preferably to be between at least 0.002 s² and not more than 0.008 S². The activity time Δt is preferably not more than 1 s, and the draw rate R is preferably not more than 100 s⁻¹.

In one preferred variant of the invention the activity ratio Γ is influenced via the draw ratio r, which is defined by D/d=v_{web}/V₀, where D is the height of the exit slot of the applicator mechanism and d is the layer thickness of the PSA film deposited on the deposition element, and v₀ is the velocity at the exit slot. A reduction in the draw ratio is accomplished preferably through the shaping of the adhesive exit slot D in the applicator mechanism during coating. In this way, surprisingly, PSAs of low anisotropy or complete isotropy are obtained, despite the fact that they undergo significant shearing in the applicator mechanism. With the method of the invention, as set out in further detail in the description, the examples, and the claims, pressure-sensitively adhesive products comprising low- or no-anisotropy PSAs are obtained advantageously and, where appropriate, in combination with additional operating parameter settings.

As already stated, the present invention describes preferably solvent-free methods which, in connection with the production of pressure-sensitively adhesive products, make it possible to furnish PSAs with only a low degree of anisotropy, or with no degree of anisotropy at all, during coating, in spite of a draw operation. With the present method regime, the invention gives rise to PSAs having only a reduced degree of anisotropy or none at all. Where appropriate, further method precautions are taken which allow any anisotropy that has developed to be abated.

The inventive production of the desired PSAs employs conventional coating operations which comprise, as operational elements, an adhesive supply system, an applicator mechanism, placement elements with, where appropriate, a medium on which the PSA film is deposited, a crosslinking station where appropriate, and a heating station where appropriate, such as a thermal tunnel, for example.

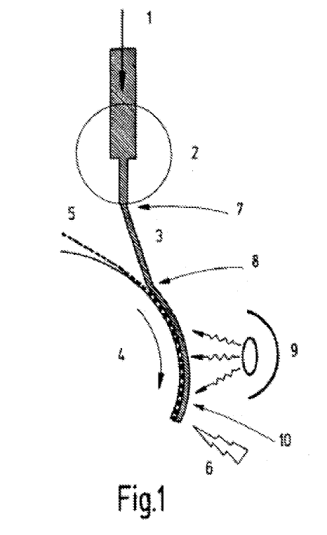

FIG. 1 shows, diagrammatically, various preferred operating segments which symbolize a preferred method sequence. Reference numerals in the figure are defined as follows:
(1) adhesive supply line;
(2) applicator mechanism or coating assembly;
(3) melt web;
(4) counter-roll;
(5) optionally employable, separately supplied deposition medium;
(6) optionally employable crosslinking station;
(7) exit slot;
(8) point of placement;
(9) optionally but advantageously employable thermal tunnel;
(10) exit point of the adhesive film from the thermal tunnel.

Detail (8) should be understood as a projection of the placement line that is actually present, resulting from the deposition of the melt web—i.e., in principle, of one surface—to another surface, namely the surface of the counter-roll or of the optionally employable deposition medium.

The diagrammatic representation in FIG. 1 describes a preferential variant and should not be understood as an exclusive configuration of operational elements and operating segments for a method of the invention. Instead, the siting of individual segments relative to one another, and also their form, may be different from what is shown. Angles and dimensions are not to scale.

As already mentioned, the method of the invention can be carried out with all PSA processing operations in which a melt web is involved during the coating operation. By a melt web (detail (3) in FIG. 1) is meant, for the purposes of this invention, a PSA film which is free on at least two sides and which is located between the exit slot (detail (7)) of the applicator mechanism or coating assembly (detail (2)) on the one hand and the point of placement (detail (8)) on the deposition element on the other hand. By deposition element is meant, for the purposes of this invention, detail (4), optionally in combination with detail (5).

In a production operation of this kind, as is known, the choice of a difference in velocity between the flow of adhesive on exit from the applicator mechanism and the point of placement results in a draw process taking place. This draw operation is associated with a deformation of the PSA film. The nature of this deformation is determined substantially by extension. The drawing of films can be utilized in order to set layer thicknesses when there are no available exit slots having the desired dimensions or when smaller exit slots cannot be used for other reasons, such as an impermissible buildup of pressure within the coating assembly, for example (further reasons have been set out earlier on above in connection with the advantages of melt webs integrated into operations). Additionally, however, within the film, there is also molecular orientation of structurally anisotropic formulation constituents and also chain stretching of flexible polymer molecules, thereby resulting in an anisotropic PSA film. Depending on the nature of the coating assembly, there is shearing and/or extension of the PSA formulation in the adhesive applicator mechanism. Shearing as well, and also in combination, when present with extension, lead to orientation of structurally anisotropic formulation constituents and also chain stretching of flexible polymer molecules in the adhesive applicator mechanism. Important, finally, is the degree of anisotropy the PSA has at the point of placement (detail 8 in FIG. 1) or else, more particularly, prior to crosslinking, since via a crosslinking step it is possible to “freeze” any state of anisotropy that exists—in the sense of the object of this invention, “freezing” such a state is disadvantageous.

The method of the invention minimizes this degree of anisotropy at the point of placement or before a crosslinking step for optional implementation, leading to a reduction in the anisotropic properties of the PSA and/or of one or more of its constituents. The invention provides PSAs which possess reduced anisotropy. Furthermore, in accordance with the invention, where appropriate, further precautions are integrated into the method that contribute to the abatement of any anisotropy that has come about.

In the methods of the invention the PSA during the coating step is subjected on the one hand, within the adhesive applicator mechanism, in general, to a combination of shearing and extension, and on the other hand, subsequently, within the melt web, essentially to a planar extension. The shearing effect of the adhesive applicator mechanism generally increases as the height of the adhesive exit slot D goes down, for constant throughput. The reason for this is that, in an adhesive applicator mechanism with a reduced cross section available to the PSA there is an increase in the flow velocity, which goes hand in hand with an increase in the shear rate.

In a melt web, anisotropy comes about as a result of extension. If it is assumed that the PSA in the melt web is extended planarly, then, in the event the PSA is incompressible, it is the case that that dimension of a volume element of the PSA that is parallel to the direction of extension (given in the method by the machine direction) increases in the same proportion by which another dimension is reduced (in the operation, the normal direction, film thickness), while the third dimension (in the operation, the transverse direction, web width) remains unchanged.

In actual fact the planar extension represents an ideal case for deformation that occurs. In actual operations a reduction in layer thickness is typically accompanied by a certain contraction (“neck-in”) of the PSA film during drawing, in other words a tapering in the width of the PSA layer after exit from the coating assembly. If the amount of this neck-in is small in comparison to the web width in coating operations, then the draw operation can be described in good approximation by way of the formalism of planar extension. The method of the invention can be used to implement all those operations which include the drawing of a melt web and which, furthermore, exhibit neck-in on the part of the PSA film.

Drawing of the melt web is given by the ratio of the exit slot D (detail (7) in FIG. 1) of the applicator mechanism to the layer thickness d of the PSA film at the point of placement (detail (8) in FIG. 1). This ratio may here be called the draw ratio r, where

r=D/d=v_{web}/v₀ (1).

In equation (1) v_{web} is the web velocity and v₀ is the velocity of the PSA film at point (7). The higher the value of the draw ratio, the higher the extensional stress on the PSA film in the melt web. This illustrates the qualitative influence of the layer thickness of the PSA film at the point of placement and in the exit slot of the applicator mechanism. In one preferred version of the invention the parameters of the draw ratio are set beforehand in such a way as to produce only a small effect with regard to the generation of orientation and chain stretching.

This invention is based on our own finding that a reduction in the shearing in the adhesive applicator mechanism as a result of an increase in the size of the exit slot leads at the same time to an increase in the extensional stress on the PSA in the melt web as a result of an increase in the draw ratio when the ultimate layer thickness is to remain unchanged. The method of the invention permits the production of PSAs with reduced anisotropy or without anisotropy with the primarily shearing influence of the adhesive applicator mechanism—more particularly when it comprises, for example, dies or similar assemblies—and the extending character of the melt web being matched to one another accordingly.

The operating parameters in the area of the coating and at the point of placement are preferably selected such that the PSA, although undergoing a high level of shearing in the adhesive applicator mechanism and on exit, nevertheless undergoes reduced drawing in the melt web.

In one advantageous embodiment of the inventive method, therefore, the parameters of exit slot D and layer thickness d of the PSA film at the point of placement are chosen so as to result in an extremely low draw ratio. Preferred draw ratios according to the invention are not more than 4:1, preferably not more than 2:1, very preferably not more than 1.5:1. It is a preferred version of the invention to realize such a draw ratio by way of a particularly small exit slot D.

Desired layer thicknesses d are typically between 1 μm and 2000 μm, preferably between 5 μm and 1000 μm.

In one advantageous embodiment of this invention this exit slot D is preferably not more than 300 μm in size, very preferably not more than 150 μm in size, more preferably not more than 115 μm in size. The layer thickness d of the deposited PSA film in this advantageous case is not more than 300 μm, 150 μm or 115 μm.

TABLE 1

| Parameter | Symbol | Definition |
|---|---|---|
| Activity time | Δt | Residence time of the PSA in the |
| | | melt web. |
| Draw rate | R | Time derivation of the draw ratio. |
| Inventive | Γ = Δt/R | Ratio of activity time to draw |
| activity ratio | | rate. |
| Plateau modulus | G_{N}⁰ | Storage modulus in the rubber- |
| | | elastic regime. Material-specific |
| | | parameter. |
| Longest | T_{D} | Disentanglement time. Material- |
| relaxation time | | specific parameter. |
| Degree of | Z | Number of entanglements per chain. |
| entanglement | | Material-specific parameter. |
| Maximum chain | λₘₐₓ | Material-specific parameter. |
| stretchability | | |
| Layer thickness | d | Film thickness of the PSA film at |
| | | the point of placement of the |
| | | deposition element. |
| Exit slot | D | Film thickness of the PSA film on |
| | | exit from the coating assembly. |
| Draw ratio | r | Ratio of exit slot of the |
| | | applicator mechanism to the layer |
| | | thickness of the PSA film at the |
| | | point of application of the |
| | | deposition element. |
| Web velocity | v_{web} | Transport velocity of the |
| | | deposition element. |
| Initial velocity | v₀ | Velocity of adhesive on exit from |
| | | the applicator mechanism (point |
| | | (7) in FIG. 1). |
| Length of melt | L | Length of the free PSA film |
| web | | between points (7) and (8) in |
| | | FIG. 1. |
| Chain stretching | λ | Measure of anisotropy. |
| Molecular | Ω | Ratio of preferential orientation |
| orientation | | of the longitudinal ellipsoid axes |
| | | along the machine direction to |
| | | preferential orientation along the |
| | | transverse direction. Measure of |
| | | anisotropy. |

It is an inventive embodiment of the method, moreover, to optimize the influence of the melt web further with a view to reducing the capacity for anisotropy to be generated, and to adapt all further operating variables which lead to a reduction of anisotropy in the PSA. In this context the first thing to mention is the length of the melt web. This operational parameter influences on the one hand the dwell time of the PSA in the melt web, Δt (“activity time”) and also, on the other hand, the draw rate R. Via both variables, additionally, it is possible advantageously to exert influence on the reduction or avoidance of anisotropy that has been generated. The activity time Δt and the draw rate R differ in their influence on the development of anisotropy in PSAs during processing. Whereas the draw rate is linked directly to the actual extension of the PSA, specifically such that the higher the draw rate, the greater the extent to which the resulting anisotropy is pronounced, the activity time represents a time period over which this anisotropy can be built up at all. For the purposes of this invention, very low draw rates are utilized. Furthermore, it is particularly advantageous if low activity times as well are realized as far as possible in the operation. These qualitative statements will be given a formula wise underpinning below.

The activity time is the time increment during which one volume element of the PSA is located in the melt web. In this context this time increment is designated the activity time Δt and, for the point of placement (detail (8) in FIG. 1) is given by

Δt=2 Lr/[v_{web}(1+r)] (2).

In equation (2), L is the length of the melt web, v_{web} is the web velocity, and r is the draw ratio. Equation (2) can be derived from considerations relating to the uniformly accelerated motion (on this point see, for example, H. Stocker (ed.), Taschenbuch der Physik, 2nd edition, 1994, Verlag Harri Deutsch, Frankfurt a.M., p. 12). Principles are formed by the two laws of motion

s(t)=at²/2+v₀t+s₀ (3)

and

v(t)=at+v₀ (4)

where s(t) is the time-dependent spatial coordinate, a is the acceleration, v₀ is the velocity at the beginning of the operation under consideration, in other words when the PSA film exits the coating assembly, so is set Ω and v(t) is the time-dependent velocity. By using equation (4) it is possible to eliminate a in equation (3). If the point of placement (8) in FIG. 1 is considered, then t becomes Δt, s(t=Δt) becomes L and v(t=Δt) becomes v_{web}. Using these boundary conditions, the result, after a certain amount of algebra, is

L=v_{web}Δt(r+1)/2r (5),

from which it is possible to derive equation (2) as the determining equation for the activity time. The formalism specified here is intended to serve to illustrate the effect of the length of the melt web on the activity time. To the skilled worker it is obvious that draw operations may deviate from the ideal case of uniformly accelerated motion. Accordingly it is possible in accordance with the invention to employ not only those methods which correspond fully to the description above but also those which are defined by the further observations in this description and in the claims.

For the purposes of the interpretation of this invention that is under discussion here, it is particularly advantageous to give an optimized setting to all of the other operating parameters which, via the activity time, have a positive influence on avoiding or reducing the capacity for anisotropy to be generated. This finding of ours can be developed further, advantageously, by using, in the operation, a web velocity which is increased to an optimum degree, in combination with a throughput which is likewise increased and is suitably adapted to the web velocity, so that these method parameters as well are used to lower the activity time. A melt web which is not too long then allows these influencing parameters to have only a limited activity on the PSA or one or more of its constituents, so that advantageously low degrees of anisotropy can be generated by way of this inventive path.

In the method of the invention the activity time Δt is preferably not more than 1 s, more preferably not more than 0.5 s.

In the above-described preferred embodiment of this invention, the influence of the length of the melt web on the activity time was shown; in that context, a melt web which is not too long is to be chosen for the method of the invention. However, in a further advantageous embodiment of this invention, it is favorable to realize the desired reduced anisotropy generation in PSAs by employing a melt web which is not too short. In this case the draw rate R is being influenced, since a melt web length which is not too short leads to reduced draw rates. Via these reduced draw rates it is possible to generate reduced degrees of anisotropy in PSAs.

The draw rate R has an influence on the degree of generated anisotropy on the part of the PSA at the point of placement, since it acts directly on the time profile and on the effectiveness of the extension operation, and hence on the deformation of the PSA film. The lower the draw rate, the lower the inherent degree of anisotropy of the PSAs at the point of placement. Generally speaking, the draw rate represents the time derivation of the draw ratio r. For the point of placement (detail (8) in FIG. 1) it can be reproduced by

R=v_{web}(r−1)/(Lr) (6),

where v_{web} describes the velocity of the deposition element, L the length of the melt web, and r the draw ratio. Like equation (2) before it, equation (6) as well, results from our own considerations an uniformly accelerated motions. The draw rate R, at the point of placement (detail (8) in FIG. 1), at which t=Δt, s(t=Δt)=L, and v(t=Δt)=v_{web}, depends only on the differential velocity which prevails within the melt web, i.e., Δv=v_{web}−v₀. For this point it is possible to fomulate

R=Δv/L=(v_{web}−v₀)/L (7)

Instead of v₀, v_{web}/r is used, thereby resulting, finally, in equation (6). As for the activity time before, the formalism presented here is based on the assumption that the inventive operation can be represented by a uniformly accelerated motion. However, this observation serves merely to underpin and to elucidate the intention of this invention. The use of this formalism for this purpose does not restrict the amount of the inventively employable operations to those methods which can be fully described by way of it. Instead, it is also possible in accordance with the invention to employ all versions which are still defined in the further observations.

For the purposes of the invention it is particularly advantageous to give an optimized setting to all of the other operating parameters which by way of the draw rate exert a positive influence on the avoidance or reduction of the capacity for anisotropy to be generated. An example that may be mentioned in this respect is a low web velocity.

Inventive draw rates amount preferably to not more than 100 s⁻¹, with particular preference not more than 50 s⁻¹, very preferably not more than 10 s⁻¹.

In summary it can be said that a low activity time and a low draw rate, independently of one another or else in combination, are advantageous for the purposes of this invention. For an inventively low activity time, a melt web length which is not too great will preferably be set. For an inventively low draw rate, a melt web length which is not too short will be chosen. Accordingly a range of values is produced for melt web lengths which can be used advantageously in accordance with the invention. A melt web is inventive when it lies preferably in the range between 20 mm, inclusive, and 80 mm, inclusive, preferably in the range between 30 mm, inclusive, and 60 mm, inclusive, very preferably between 35 mm, inclusive, and 50 mm, inclusive.

In the above part of this description it has been shown how it is possible to exert influence on the reduced generation of anisotropy in PSAs in an inventive and advantageous way via the length of the melt web in a coating operation. The length of the melt web has a different effect on the parameters of activity time and draw rate, which both, either individually or in combination with the other one, and/or, optionally, also in combination with further method parameters, can lead to the development of anisotropy in PSAs.

As already remarked, these two parameters can be united to give the new criterion, the inventive activity ratio Γ, which is given by

Γ=Δt/R (8).

If the respective determining equations for the activity time, equation (2), and the draw rate, equation (7), are inserted into equation (8), then Γ takes on the following form:

Γ=2(Lr)²/[v_{web}(r²−1)] (9).

In accordance with the observations made above, a reduction in the activity time produces lower degrees of anisotropy. Similarly, a reduction in the draw rate also leads to lower degrees of anisotropy. According to equation (9) there is an advantageous range of values for F. In accordance with the invention it is possible to use all coating operations for PSAs for which it is possible to formulate an activity ratio F of between 0.002 S², inclusive, and 0.008 S², inclusive, preferably between 0.004 S², inclusive, and 0.006, inclusive, in accordance with the observations and approximations made above.

Equation (9) illustrates the influence of the length of the melt web, L, on the inventive activity ratio. Moreover, it is evident from equation (9) that the method parameter of web velocity, v_{web}, also has an importance influence on the inventive activity ratio Γ. These parameters are therefore selected advantageously in combination with the length of the melt web in the coating operation in such a way that they allow an optimum effect on Γ and hence the avoidance or reduction of anisotropy in PSAs.

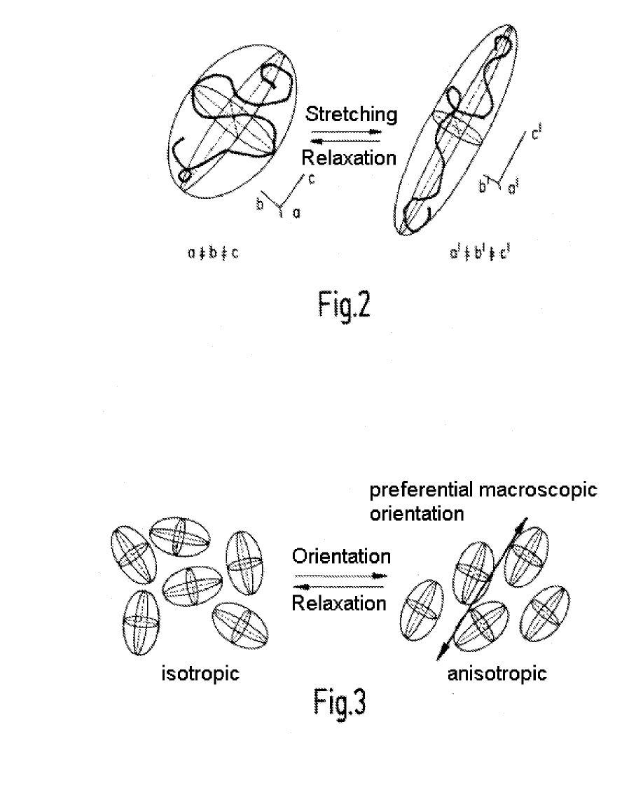

The present invention relates preferably to the production of PSAs which in the raw state, in other words in the chemically or radiation-chemically uncrosslinked state, represent normewtonian fluids, and more particularly, specifically, represent normewtonian fluids which are structurally viscous in nature. Normewtonian fluids exhibiting structural viscosity are distinguished by the fact that, above critical shear rates, they exhibit a shear-rate-dependent viscosity. Structurally viscous behavior is connected with a change in the structure of individual constituents of the formulation, more particularly of long-chain polymers, when there are changes in the flow state. For polymers this behavior can be described on a model basis to mean that, in accordance with the state of flow, the molecular structure changes so as to attain a flow resistance which is lower than that of the undeformed polymers. This is accomplished on the one hand by the stretching of individual chains and also by molecular orientation. The envelope of a polymer chain can be represented in general terms by an ellipsoid. Chain stretching is linked with a change in the ellipsoid geometry, such as an elongation, for example (FIG. 2), orientation with the alignment of two or more such ellipsoids along a preferential direction (FIG. 3). Possibilities for the quantification of chain stretching and molecular orientation, and the matter of how these variables can be utilized as a criterion for anisotropy, are addressed in the “Examples” section. If there is a change in the state of flow, then the structure of the polymer chains and the orientation adapt to the new circumstances. Opposing orientation operations and chain stretching events are relaxation processes, with the consequence that, if the flow process is halted without further external stimulation, a restructuring of the PSA occurs and, as a consequence of this, the state regains the structural equilibrium which prevailed before the beginning of the flow operation. However, this “reverse reaction” takes place only if the system retains a certain internal mobility. Critical to the orientation, chain-stretching, and relaxation behavior of polymers in PSAs is the nonlinear Theological behavior under steady-state conditions, but also under transient conditions—since in actual operations the PSA system typically moves in a changing flow profile. In good approximation, the Theological behavior of such PSAs is described by four material parameters: the plateau modulus G_{N}⁰, the longest relaxation time T_{D}, the degree of entanglement per polymer chain Z, and the maximum chain stretchability λₘₐₓ. A more precise description of these variables is given by Fang et al. [J. Fang, M. Kröger, H. C. Ottinger, J. Rheol., 2000, 44, 1293].

Attention has already been drawn to the fact that orientation and chain-stretching operations are opposed by relaxation events. In a further embodiment of this invention, this phenomenon, predetermined by nature, is utilized advantageously, optionally also in combination with the above-described advantageous method embodiments. PSAs based on low-solvent or solvent-free polymers are above their softening temperature under processing conditions. The polymers present therefore have an internal mobility on various scales of length and time that is attributable to what is called self-diffusion, a statistical motion process. It involves long-range relaxation processes in the area of entire polymer chains, via which any states of anisotropy are abated principally through long-term relaxation. The long-term relaxation behavior is material-dependent and can be described in simplified form by the variable T_{D}. Like all relaxation events, the long-term relaxation is also temperature-dependent and can be accelerated by temperature increase.

For the purposes of this invention, therefore, coating is carried out preferably at very high temperatures. Inventive coating temperatures depend on the nature of the PSA to be coated. Typically such coating temperatures are located between 50° C. and 250° C., preferably between 75° C. and 200° C. The temperature of the counter-roll (detail (4) in FIG. 1) is likewise chosen as high as is possible. Preference is given inventively to temperatures of at least 30° C., more particularly of at least 60° C. It is advantageous for the PSA film to pass through a heating zone, of any kind, at any point in time after departing the applicator mechanism.

For this purpose the methods of the invention may preferably include a thermal tunnel as an operating element, in order to expose the coated PSA film to an elevated temperature. Heat is supplied, for example, by electrical heating, air heated by fossil energy sources, and/or infrared radiation. It is operated preferably at least 60° C., very preferably at least 90° C. It is in accordance with the invention here for the temperature to be preferably constant over the entire length of the thermal tunnel. For the purposes of this invention it is likewise possible for the thermal tunnel to have a temperature profile—in other words, for example, a temperature gradient. For the purposes of this invention there is no restriction on the length of the thermal tunnel. For the purposes of this invention, preferably, heating is carried out between the placement of the melt web onto the deposition element and a crosslinking step, in order to accelerate the relaxation of any anisotropic state that may have been generated. Since the carrier materials or liner materials used are not arbitrarily temperature-stable, the melt film, in one advantageous embodiment of this invention, may be deposited onto a more temperature-stable transport medium and guided on that medium through the thermal tunnel, being transferred only thereafter to a desired carrier or liner. As a transport medium it is possible with advantage to make use, for example, of more temperature-stable film carriers based on polyester, polyamide or polyimide, or papers, circulating conveyor belts, release rolls, or other sheetlike materials, in each case advantageously provided with a durable release layer. The thermal tunnel can also be operated in combination with a drying unit in order to eliminate any solvents employed.

In accordance with the invention, PSAs with low or no anisotropy are produced. The anisotropy is quantified on the basis of numerical data, namely on the basis of the chain stretching and molecular orientation. The two phenomena serve as description variables for anisotropy that are each independent in principle of the other, it being the case for both that a numerically low amount implies a low degree of anisotropy.

In the method of the invention the supply of adhesive is accomplished by means of typical assemblies for conveying viscous media, preferably by extruders that are customary in plastics processing and in the adhesive tape industry, or other suitable assemblies for softening/melting and conveying thermoplastic media. These may be, for example, typical adhesive-industry drum melters, premelters, melt pumps or other melting and conveying systems, with combinations of different such elements also being useful. The term extruder for the purposes of this description also comprehends other suitable abovementioned melting and conveying systems. Also in accordance with the invention is the combination of extruder and melt pump, which in this case can be used with advantage for improving the consistency of conveying. Suppliers of melt pumps of this kind include, for example, the companies Maag (Zurich, Switzerland) or Witte (Itzehoe, Germany).

A preferred application method used for the purposes of this invention is a slot die. The types of extrusion die used with great preference in accordance with the invention are subdivided into the categories of T-dies, fishtail dies, and coat hanger dies. The stated types differ in the design of their flow channel, resulting in different residence times and distribution strategies. For producing coatings of the invention based on polyacrylates it is preferred to employ coathanger dies, of the kind offered, for example, by the companies Extrusion Dies, Inc. (Chippewa Falls, USA) or Reiffenhauser (Troisdorf, Germany). For the purposes of the invention, however, it is also possible to employ other coating methods which operate with a melt web, such as the hotmelt curtain coating method (Inatech, Langenfeld, Germany or Nordson, Lüneburg, Germany), for example. Reference is also to combinations of an extrusion die and a calender method or derived roll application methods, such as smoothing rolls or other assemblies with a melt web that, by means of an extrusion die, utilize melt premetering into a calender nip. Examples here would include roller-head units from Troester, Hanover, or polymer-film units and plastic-sheet units from Kuhne, St Augustin.

The PSA film spread out in flat form is deposited in accordance with the invention preferably onto a carrier material or release material.

For producing the carrier film it is possible in principle to use all film-forming and extrudable polymers. One preferred embodiment uses polyolefins. Preferred polyolefins are prepared from ethylene, propylene, butylene and/or hexylene; in each case, it is possible to polymerize the pure monomers, or mixtures of the stated monomers are copolymerized. Through the polymerization process and through the selection of the monomers it is possible to control the physical and mechanical properties of the polymer film, such as the softening temperature and/or the tear strength, for example.

A further preferred embodiment of this invention uses polyvinyl acetates. Polyvinyl acetates may include vinyl alcohol as a comonomer besides vinyl acetate, with the free alcohol fraction being widely variable. A further preferred embodiment of this invention uses polyesters as carrier film. One particularly preferred embodiment of this invention uses polyesters based on polyethylene terephthalate (PET). A further preferred embodiment of this invention uses polyvinyl chlorides (PVC) as film. To raise the temperature stability, the polymer constituents of these films may be prepared using stiffening comonomers. Furthermore, in the course of the inventive operation, the films may be radiation-crosslinked in order to obtain such improvement in properties. Where PVC is employed as a film base material, it may optionally comprise plasticizing components (plasticizers). One further preferred embodiment of this invention uses polyamides for producing films. The polyamides may be composed of a dicarboxylic acid and a diamine or of two or more dicarboxylic acids and diamines. Besides dicarboxylic acids and diamines it is also possible to use higher polyfunctional carboxylic acids and amines, both alone and in combination with the abovementioned dicarboxylic acids and diamines. To stiffen the film it is preferred to use cyclic, aromatic or heteroaromatic starting monomers. One further preferred embodiment of this invention uses polymethacrylates for producing films. In this case it is possible through the choice of the monomers (methacrylates and also, in some cases, acrylates) to control the glass transition temperature of the film. Furthermore, the polymethacrylates may also comprise additives, in order, for example, to increase the flexibility of the film or to raise or lower the glass transition temperature, or to minimize the formation of crystalline segments. One further preferred embodiment of this invention uses polycarbonates for producing films. Further, in one further embodiment of this invention, polymers and copolymers based on vinylaromatics and vinylhetero-aromatics may be used to produce the carrier film. To produce a filmlike material it may also be appropriate here to add additives and further components which improve the film-forming properties, reduce the tendency for crystalline segments to form and/or selectively improve or even, where appropriate, impair the mechanical properties.

To produce an inventively preferred release film it is likewise possible in principle to use all film-forming and extrudable polymers. In one preferred embodiment of the invention the release film is composed of a carrier film provided on both sides with a release varnish, which is based preferably on silicone. In one very preferred embodiment of the invention the release varnishes are graduated, i.e., the release values differ on the top and bottom faces. This ensures that the double-sided pressure-sensitively adhesive product or intermediate can be unwound. One preferred embodiment of this invention uses polyolefins as carrier material for the release film. Preferred polyolefins are prepared from ethylene, propylene, butylene and/or hexylene, it being possible in each case to polymerize the pure monomers or to copolymerize mixtures of the stated monomers. Through the polymerization process and through the selection of the monomers it is possible to control the physical and mechanical properties of the polymer film, such as the softening temperature and/or the tear strength, for example.

Also suitable as carrier material for release materials are diverse papers, optionally also in combination with a stabilizing extrusion coating. One or more coating passes with, for example, a silicone-based release give all of the stated release carriers their antiadhesive properties. The application may take place to one or both sides.

The film that is formed in the coating die is placed onto the carrier material or release material, called simply carrier material below, in, for example, a distance coating operation. In this operation the distance between the exit point on the applicator mechanism and the point of placement on the placement element is greater than the layer thickness at the point of placement. A melt web is formed whose geometry is laid down by the distance between the exit point of the applicator mechanism (detail (7) in FIG. 1) and the point of placement (detail (8) in FIG. 1) on the deposition element, optionally on the carrier material. The placement line is generated by a customary placement technique—this may take place, for example, via a suitable air knife, by a vacuum box, where appropriate in combination with an air knife, or via electrostatic placement devices. The carrier thus coated is preferably guided over a driven roll which can be cooled or heated. Alternatively, the melt web can be placed on arrangements such as conveyor belts, antiadhesively coated rotating elements, or rolls provided with a fluid coat, for example, and transferred to the carrier material in a downstream transfer unit (“laminating station”).

It is particularly advantageous if the coating step is followed where appropriate by a crosslinking step. Appropriate crosslinking converts the PSA film into a material distinguished not only by good adhesive properties but also by good cohesive properties. In the operation for the purposes of this invention the crosslinking step is employed advantageously at a point in time such that relaxation has already caused sufficient abatement of any anisotropy, this abatement being partial, preferably almost complete or, very preferably, complete. Particularly suitable for use are radiation-chemical crosslinking processes which utilize UV radiation and/or electron beams. An important parameter here is the period between the deposition of the free PSA film on the deposition element and the time of crosslinking, since relaxation occurs to an increased extent within said period. It is particularly advantageous if during this time the PSA passes through a thermal tunnel corresponding to the above description. A crosslinking station is integrated in the operation inventively when the crosslinking operation acts on the PSA film after a time span between exit of adhesive from the applicator mechanism and crosslinking of at least 1 s, preferably at least 5 s, very preferably at least 15 s. It is possible, however, to employ any form of thermal crosslinking, including different forms of such crosslinking, both alone and in combination with radiation-chemical crosslinking processes.

As pressure-sensitive adhesives (PSAS) it is possible to employ all linear, star-shaped, branched, grafted or otherwise-architectured polymers, preferably homopolymers, random copolymers or block copolymers, which have a molar mass of at least 100 000 g/mol, preferably of at least 250 000 g/mol, very preferably of at least 500 000 g/mol. Preference is given to a polydispersity, formed as the ratio of mass average to number average in the molar mass distribution, of at least 2. Preference is also given to a softening temperature of less than 20° C. The molar mass in this context is the weight average of the molar mass distribution, as is accessible, for example, by way of gel permeation chromatography analyses. By softening temperature in this context is meant the quasistatic glass transition temperature for amorphous systems, and the melting temperature for semicrystalline systems; these can be determined, for example, by dynamic differential calorimetry measurements. Where numerical values are reported for softening temperatures, they refer to the midpoint temperature of the glass stage in the case of amorphous systems, and to the temperature at maximum heat change during the phase transition in the case of semicrystalline systems.

As PSAs it is possible to use all of the PSAs known to the skilled worker, more particularly systems based on acrylate, natural rubber, synthetic rubber or ethylene-vinyl acetate. Combinations of these systems can also be employed in accordance with the invention.

Without wishing to impose any restriction, examples that may be given of systems that are advantageous for the purposes of this invention include random copolymers starting from unfunctionalized α,β-unsaturated esters, and random copolymers starting from unfunctionalized alkyl vinyl ethers. Preference is given to using α,β-unsaturated alkyl esters of the general structure

CH₂═CH(R¹)(COOR²) (I)

where R¹ is H or CH₃ and R² is H or linear, branched or cyclic, saturated or unsaturated alkyl radicals having 1 to 30, more particularly having 4 to 18, carbon atoms.

Monomers which are used very preferably in the sense of the general structure (I) include acrylic and methacrylic esters with alkyl groups consisting of 4 to 18 C atoms. Specific examples of corresponding compounds, without wishing to be restricted by this enumeration, are n-butyl acrylate, n-pentyl acrylate, n-hexyl acrylate, n-heptyl acrylate, n-octyl acrylate, n-nonyl acrylate, lauryl acrylate, stearyl acrylate, stearyl methacrylate, their branched isomers, such as 2-ethylhexyl acrylate and isooctyl acrylate, for example, and also cyclic monomers, such as cyclohexyl or norbornyl acrylate and isobornyl acrylate, for example.

Likewise possible for use as monomers are acrylic and methacrylic esters which contain aromatic radicals, such as phenyl acrylate, benzyl acrylate, benzoin acrylate, phenyl methacrylate, benzyl methacrylate or benzoin methacrylate, for example.

It is additionally possible, optionally, to use vinyl monomers from the following groups: vinyl esters, vinyl ethers, vinyl halides, vinylidene halides, and also vinyl compounds which contain aromatic rings or heterocycles in α position. For the vinyl monomers which can optionally be employed, mention may be made, exemplarily, of selected monomers which can be used in accordance with the invention: vinyl acetate, vinylformamide, vinylpyridine, ethyl vinyl ether, 2-ethylhexyl vinyl ether, butyl vinyl ether, vinyl chloride, vinylidene chloride, acrylonitrile, styrene, and methylstyrene.

Further monomers which can be used in accordance with the invention are glycidyl methacrylate, glycidyl acrylate, allyl glycidyl ether, 2-hydroxyethyl methacrylate, 2-hydroxyethyl acrylate, 3-hydroxypropyl methacrylate, 3-hydroxypropyl acrylate, 4-hydroxybutyl methacrylate, 4-hydroxybutyl acrylate, acrylic acid, methacrylic acid, itaconic acid and its esters, crotonic acid and its esters, maleic acid and its esters, fumaric acid and its esters, maleic anhydride, methacrylamide and also N-alkylated derivatives, acrylamide and also N-alkylated derivatives, N-methylolmethacrylamide, N-methylolacrylamide, vinyl alcohol, 2-hydroxyethyl vinyl ether, 3-hydroxypropyl vinyl ether, and 4-hydroxybutyl vinyl ether.

In the case of rubber, or synthetic rubber, as starting material for the PSA there are further possibilities for variation, whether from the group of the natural rubbers or the synthetic rubbers, or whether from any blend of natural rubbers and/or synthetic rubbers, it being possible to choose the natural rubber or natural rubbers in principle from all available grades such as, for example, crepe, RSS, ADS, TSR or CV types, depending on the required level of purity and viscosity, and to choose the synthetic rubber or synthetic rubbers from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA), and polyurethanes and/or blends thereof.

Additionally, it is possible for the processability of rubbers to be improved by admixing them preferably with thermoplastic elastomers, with a weight fraction of 10% to 50% by weight, based on the total elastomer fraction. Representatives that may be mentioned at this point include especially the particularly compatible types polystyrene-polyisoprene-polystyrene (SIS) and polystyrene-polybutadiene-polystyrene (SBS).

As tackifying resins for optional use it is possible without exception to use all tackifier resins that are already known and have been described in the literature. As representatives mention may be made of the rosins, their disproportionated, hydrogenated, polymerized, and esterified derivatives and salts, the aliphatic and aromatic hydrocarbon resins, terpene resins, and terpene-phenolic resins. Any desired combinations of these and further resins may be used in order to set the properties of the resultant adhesive in accordance with requirements.

As plasticizers likewise for optional use it is possible to use all of the plasticizing substances known from self-adhesive tape technology. These include, among others, the paraffinic and naphthenic oils, (functionalized) oligomers such as oligobutadienes and oligoisoprenes, liquid nitrile rubbers, liquid terpene resins, vegetable and animal fats and oils, phthalates, and functionalized acrylates. PSAs of the kind indicated above may also comprise further constituents such as additives with Theological activity, catalysts, initiators, stabilizers, compatibilizers, coupling reagents, crosslinkers, antioxidants, other aging inhibitors, light stabilizers, flame retardants, pigments, dyes, fillers and/or expandants and also, optionally, solvents.

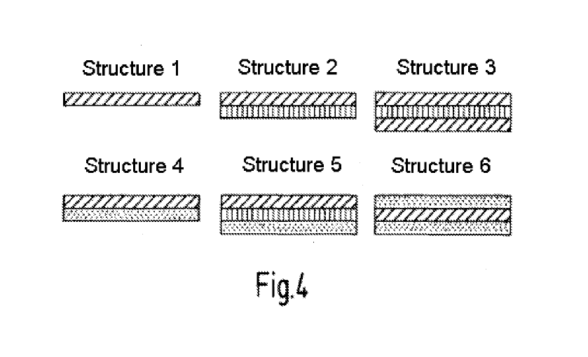

The PSAs produced by the methods of the invention can be utilized for the purpose of constructing different kinds of pressure-sensitively adhesive products. Inventive structures of pressure-sensitively adhesive products are shown in FIG. 4. Each layer in the inventive structures of pressure-sensitively adhesive products can optionally be foamed.

At its most simple, a pressure-sensitively adhesive product of the invention is composed of the PSA in a single-layer structure (structure 1). Structure 1 may optionally be lined on one or both sides with a release liner, such as a release film or release paper, for example. The layer thickness of the PSA is typically between 1 μm and 2000 μm, preferably between 5 μm and 1000 μm.

The PSA may also be situated on a carrier, more particularly on a film or paper carrier (structure 2). In this case the carrier may have been given a prior-art pretreatment on the side facing the PSA, in order, for example, to achieve an improvement in the anchoring of the PSA. The side may also have been treated with a functional layer which may function, for example, as a barrier layer. The back face of the carrier may have been given a prior-art pretreatment for the purpose, for example, of achieving a release effect. The back face of the carrier may also be printed. The PSA can optionally be lined with a release paper or release film. The PSA has a typical layer thickness of between 1 μm and 2000 μm, preferably between 5 μm and 1000 μm.

Structure 3 is a double-sided pressure-sensitively adhesive product comprising as its middle layer, for example, a carrier film, a carrier paper, a textile fabric or a carrier foam. In structure 3, the top and bottom layers employed are inventive PSAs of like or different type and/or of like or different layer thickness. In this case the carrier may have been given a prior-art pretreatment on one or both sides in order, for example, to achieve an improvement in the anchoring of the PSA. It is likewise possible for one or both sides to have been treated with a functional layer, which may function, for example, as a barrier layer. The PSA layers may optionally be lined with release papers or release films. Typically the PSA layers independently of one another have layer thicknesses of between 1 μm and 2000 μm, preferably between 5 μm and 1000 μm.

As a further double-sided pressure-sensitively adhesive product, structure 4 is one variant of the invention. A PSA layer of the invention carries on one side a further PSA layer, which, however, may be of any desired kind and therefore need not be inventive. The structure of this pressure-sensitively adhesive product may optionally be lined with one or two release films or release papers. The PSA layers have layer thicknesses, independently of one another, of between typically 1 μm and 2000 μm, preferably between 5 μm and 1000 μm.

As in structure 4, structure 5 is also a double-sided pressure-sensitively adhesive product which comprises a PSA of the invention and also any desired further PSA. The two PSA layers in structure 5, however, are separated from one another by a carrier, a carrier film, a carrier paper, a textile fabric or a carrier foam. This carrier may have been given a prior-art pretreatment on one or both sides in order, for example, to achieve an improvement in the anchoring of the PSA. It is also possible for one or both sides to have been treated with a functional layer, which may function, for example, as a barrier layer. The PSA layers may optionally be lined with release papers or release films. The PSA layers have layer thicknesses, independently of one another, of between typically 1 μm and 2000 μm, preferably between 5 μm and 1000 μm.

The pressure-sensitively adhesive product of the invention in accordance with structure 6 comprises a layer of inventive material as a middle layer, which is provided on both sides with any desired PSAs of like or different kind. One or both sides of the middle layer may have been treated with a functional layer, which may function, for example, as a barrier layer. For the outer layers of PSA it is not necessary for inventive PSAs to be employed. The outer PSA layers may optionally be lined with release papers or release films. The outer PSA layers have layer thicknesses, independently of one another, of between typically 1 μm and 2000 μm, preferably between 5 μm and 1000 μm. The thickness of the middle layer is typically between 1 μm and 2000 μm, preferably between 5 μm and 1000 μm.

The pressure-sensitively adhesive products of the invention are employed preferably in the form of self-adhesive tapes or self-adhesive sheets.

The invention is next elucidated in more detail with reference to examples, but without any intention that it should be restricted to these examples.

### WORKING EXAMPLES

Examples of the methods of the invention for generating inventively low degrees of anisotropy in pressure-sensitive adhesives (PSAs) have been obtained by computer simulations, specifically by evaluating the results of finite element (FE) calculations. Simulations constitute experiments on a computer and are therefore comparable with experimental results. The simulation procedure is described below [see also T. Dollase et al., paper given to the PSTC TECH XXVII Global Conference, Orlando, 2004].

The basis for the simulations was the arithmetic approach developed by Feigl, Laso and Öttinger and published under the name CONNFFESSIT (Calculation of Non-Newtonian Flow: Finite Elements and Stochastic Simulation Techniqe) [K. Feigl, M. Laso, H. C. Öttinger, Macromolecules, 1995, 28, 3261]. Carrying out the calculations entails passing through seven stages. The first to count for this purpose is the definition of the design of the production operation under investigation, the operating parameters, and the nature of the materials to be operated on. Subsequently the Theological profile is recorded experimentally for the materials under investigation, as an input for the simulations. After that, the Theological data are matched to a specially selected constitutive equation system. Additionally, FE meshes are set up for the above-defined operating geometries. In combination with operating parameters such as temperature and throughput, temperature, velocity, and velocity-gradient fields are drawn up in these FE meshes by means of numerical calculations. Finally, it is possible to simulate a processing operation by a volume element of the PSA flowing through the velocity field and, during its passage, undergoing different temperatures and velocity gradients in accordance with its location in the operation. These external influences cause restructuring of the material in accordance with its Theological behavior. In the final step of the simulation, data are obtained for the anisotropy in the form of the molecular orientation and the chain stretching.

Presented below are six examples which are intended to illustrate and underscore the advantages of preferred embodiments of these inventions. For all six examples simulations were conducted in accordance with the process described above. Data on the rheology of the PSA system included dynamic mechanical analyses for the investigation of the linearly viscoelastic behavior under shear, and measurements relating to the steady-state flow behavior under shear, to the time-dependent flow behavior at the beginning of a new shearing stress, and also of the time-dependent flow behavior under extension. Further data, based on experimental determinations and input to the simulations as material parameters, were the temperature dependency of the density, of the thermal conductivity, and of the specific heat capacity. These data were matched to a constitutive equation system which is especially suitable for describing the nonlinear flow behavior of interentangled polymer melts [H. C. Öttinger, J. Rheol., 1999, 43, 1461; J. Fang, M. Kröger, H. C. Ottinger, J. Rheol., 2000, 44, 1293]. This gave the four material parameters G_{N}⁰, Z, T_{D}, and λₘₐₓ and also their temperature dependency.

When FE meshes had been drawn up for the desired operating geometries, and the temperature, velocity, and velocity gradient fields had been calculated, the actual FE simulations were commenced. This was done by considering a system containing 30 000 polymer chains and monitoring the system, in a simulative flow operation, to observe how the structure of this statistical collective changed during the operation, i.e., how anisotropy came about and relaxed. The statistical collective was placed in the center of the adhesive flow at the end of the adhesive supply line and in the entry region of the coating assembly. During the FE simulations, the collective moved along flow lines which resulted from the velocity fields calculated beforehand. The anisotropy, in the form of chain stretching and molecular orientation, was recorded incrementally at points along the flow lines. Critical values were those found for the various operations under investigation and for the PSA under investigation at the point of placement on the deposition element (point 8 in FIG. 1) and on exit of the PSA film from a thermal tunnel (point 10 in FIG. 1). Low values for molecular orientation and chain stretching indicate that low degrees of anisotropy are generated via the operating embodiment carried out.

In order to be able to quantify anisotropy and hence to be able to compare results from different operating procedures with one another, numerical data are required which give a numerical description of chain stretching and molecular orientation. Each of these two phenomena serves as a description variable, in each case independent in principle from the other, for anisotropy. Both of these phenomena follow the same trend, namely that a low amount implies a low degree of anisotropy.

The description of the chain stretching is effected in the one-chain model. For chain stretching in the equilibrium state the value λ=1 is defined. In this state the envelope of a polymer chain under consideration (an ellipsoid as shown in FIG. 2) is characterized by the semiaxis values a, b, and c, which in general have different values. Chain stretching causes deformation of the ellipsoid, and so the semiaxis values take on the amounts a′, b′, and c′. The most to which the chain can be stretched is as predetermined by the material parameter λₘₐₓ. The parameter λ, which describes the state of chain stretching, can therefore take on any values from 1 to λₘₐₓ. The value λ=1 implies isotropy.

Molecular orientation is quantified via the use of eigenvalues of the orientation tensor. The approach entails a multiple-chain model. In this model, for one collective, the alignment of all the ellipsoids is averaged and investigated for any average preferential direction. The orientation tensor is spread, if deformation occurs in the machine direction, by three eigenvectors, which lie substantially parallel to the machine direction, parallel to the transverse direction, and parallel to the normal direction, respectively. The ratio Ψ formed from the eigenvalue that describes the amount of the eigenvector along the machine direction and the eigenvalue that expresses the amount of the eigenvector along the transverse direction is a quantitative measure of molecular orientation. The value of Ω adopts values from 1 in the isotropic state to ∞ (infinity) in the fully oriented state.

In Examples 1 to 4 the effect of the height of the exit slot on the anisotropy generated in the PSA at point (8) of FIG. 1 was investigated. Inventively, via the height of the exit slot, the draw ratio was influenced. The length of the melt web was 40 mm.

### Example 1

A resin-free polyacrylate according to DE 39 42 232 was coated at 170° C. onto a siliconized release paper, using an extrusion die having a coat hanger manifold with a working width of 350 mm. The die slot measured 300 μm and the length of the die lip was 60 mm. The counter-roll had a temperature of 60° C. The web velocity was 50 m/min, the layer thickness of the deposited PSA film 75 μm, and the throughput 73 kg/h.

### Example 2

A polyacrylate as also employed in Example 1 was coated at 170° C. onto a siliconized release paper, using an extrusion die having a coat hanger manifold with a working width of 350 mm. The die slot measured 150 μm and the length of the die lip was 60 mm. The counter-roll had a temperature of 60° C. The web velocity was 50 m/min, the layer thickness of the deposited PSA film 75 μm, and the throughput 73 kg/h.

### Example 3

A polyacrylate as also employed in Example 1 was coated at 170° C. onto a siliconized release paper, using an extrusion die having a coat hanger manifold with a working width of 350 mm. The die slot measured 300 μm and the length of the die lip was 20 mm. The counter-roll had a temperature of 60° C. The web velocity was 50 m/min, the layer thickness of the deposited PSA film 75 μm, and the throughput 73 kg/h.

### Example 4

A polyacrylate as also employed in Example 1 was coated at 170° C. onto a siliconized release paper, using an extrusion die having a coathanger manifold with a working width of 350 mm. The die slot measured 150 μm and the length of the die lip was 20 mm. The counter-roll had a temperature of 60° C. The web velocity was 50 m/min, the layer thickness of the deposited PSA film 75 μm, and the throughput 73 kg/h.

For Examples 1 to 4, the draw ratio was calculated and the data obtained in the simulation for chain stretching λ(8) and orientation Ω(8) at the point 8 (see FIG. 1) were plotted. The values are compiled in Table 2.

TABLE 2

| | | | | Chain | |
|---|---|---|---|---|---|
| | Exit slot | | Draw ratio | stretching | Orientation |
| | D | Die lip | r | λ(8) | Ω(8) |
| Example 1 | 300 μm | 60 mm | 4:1 | 1.60 | 5.7 |
| Example 2 | 150 μm | 60 mm | 2:1 | 1.54 | 5.1 |
| Example 3 | 300 μm | 20 mm | 4:1 | 1.60 | 5.5 |
| Example 4 | 150 μm | 20 mm | 2:1 | 1.54 | 4.8 |

Examples 1 to 4 show that an operating regime in accordance with the invention does actually lead to a reduction in the anisotropy generated. In Examples 2 and 4 an adhesive exit slot of 150 μm was chosen in each case, whereas in Examples 1 and 3 the adhesive exit slot was 300 μm. The layer thickness in the deposited PSA film was 75 μm in all cases, so that by reducing the height of the adhesive exit slot there was a reduction in the draw ratio from 4:1 (Examples 1 and 3) to 2:1 (Examples 2 and 4). Although the shearing on exit from the coating assembly increases when an exit slot of 150 μm is used rather than a 300 μm slot, a further-reduced degree of anisotropy is achieved for the PSA film deposited. This is evident in even lower values for the chain stretching λ(8) and orientation Ω(8) when the 150 μm die is used, in comparison to the use of a 300 μm die.

In two further examples the further reduction of anisotropy through the inventive use of a thermal tunnel was investigated. The thermal tunnel was integrated into the operation in such a way that the PSA film entered the tunnel while still at the point of placement (detail (8) in FIG. 1), and the PSA film then extended along the ongoing web for a length which is indicated in the examples. The temperature in the tunnel had a constant value over its entire length.

### Example 5

A polyacrylate as also employed in Example 1 was coated at 170° C. onto a siliconized release paper, using an extrusion die having a coat hanger manifold with a working width of 350 mm. The die slot measured 300 μm and the length of the die lip was 60 mm. The length of the melt web was 40 mm. The counter-roll had a temperature of 60° C. The web velocity was 50 m/min, the layer thickness of the deposited PSA film 75 μm, and the throughput 73 kg/h. In addition a thermal tunnel was employed which had a length of approximately 1.5 m and was operated at a temperature of 60° C.

### Example 6

A polyacrylate as also employed in Example 1 was coated at 170° C. onto a siliconized release paper, using an extrusion die having a coathanger manifold with a working width of 350 mm. The die slot measured 300 μm and the length of the die lip was 60 mm. The length of the melt web was 40 mm. The counter-roll had a temperature of 60° C. The web velocity was 50 m/min, the layer thickness of the deposited PSA film 75 μm, and the throughput 73 kg/h. In addition a thermal tunnel was employed which had a length of approximately 16 m and was operated at a temperature of 60° C.

For Examples 5 and 6, the draw ratio was calculated and the data obtained in the simulation for chain stretching λ(10) and orientation Ω(10) at the point 10 (see FIG. 1), i.e., after exit from the thermal tunnel, were plotted. The values are compiled in Table 3.

TABLE 3

| | Draw ratio | Thermal tunnel | Chain stretching | Orientation |
|---|---|---|---|---|
| | r | length | λ(10) | Ω(10) |
| Example 5 | 4:1 | approx. 1.5 m | 1.31 | 3.61 |
| Example 6 | 4:1 | approx. 16 m | 1.006 | 1.002 |

Examples 5 and 6 show clearly that a thermal tunnel, whose use is optional, has a significant influence on the remanent anisotropy of an inventively coated PSA film. For the simulated PSA, even a mild temperature of 60° C. leads to a clear and additional reduction in anisotropy, when the results are compared, for example, with those from Example 1. A version of the method in accordance with Example 6 in fact leads to an almost complete elimination of anisotropy, which is implied by a chain stretching value of 1.006 and an orientation value of 1.002. In the case of complete isotropy, both variables take on an amount of 1. A higher temperature in the thermal tunnel would lead to accelerated relaxation of any anisotropic states present in the PSA film, with the consequence that, in the case, shorter thermal tunnels can also be effectively employed.

### LIST OF REFERENCE NUMERALS

1 adhesive supply line
2 applicator mechanism or coating
3 melt web
4 counter-roll
5 optionally employable, separately deposition medium
6 optionally employable crosslinking
7 exit slot
8 point of placement
9 optionally but advantageously thermal tunnel
10 point of exit of the adhesive film the thermal tunnel

1-26. (canceled)

27. A method for producing low- or no-anisotropy pressure-sensitive adhesives (PSAs), comprising the steps of
providing, as operating elements, an adhesive supply system, an applicator mechanism and a placing element,
forming, between the exit of the applicator mechanism and point of placement on the deposition element, a free melt web of the PSA, which undergoes a draw operation, controlling the drawing of the PSA in the free melt web via a setting of an activity ratio Γ which is characterized as the ratio of activity time Δt in the draw operation to the draw rate R, and which is set to a level of not more than 0.008 s the activity time Δt being defined by the formula 2 Lr/[v_{web}(1+r)], in which L is the length of the melt web, r is the draw ratio, and v_{web} is the velocity of the melt web, and the draw rate R is defined as the time derivation of the draw ratio r.

28. The method of claim 27, wherein the activity ratio F is set to a level of 0.002 s² to 0.008 s².

29. The method of claim 27, wherein the activity ratio F is set to a level of 0.004 s to 0.006 s².

30. The method of claim 27, wherein the draw ratio r, which is defined by D/d=v_{web}/v₀, where D is the height of the exit slot of the applicator mechanism and d is the layer thickness of the PSA film deposited on the deposition element, and v₀ is the velocity at the exit slot, is not more than 4:1

31. The method of claim 30, wherein the draw ratio is set by varying the height D of the exit slot to the layer thickness d of the PSA deposited on the deposition element.

32. The method of claim 31, wherein the height D of the adhesive exit slot is not more than 300 μm.

33. The method of claim 27, wherein the chosen layer thickness d is between 1 and 2000 μm.

34. The method of claim 27, wherein for the PSA in the melt web the ratio Γ is realized such that the length of the melt web is between at least 20 mm and not more than 80 mm.

35. The method of claim 27, wherein the activity time Δt has a value of not more than 1 s.

36. The method of claim 27, wherein the PSA in the melt web is subjected to a draw rate R of not more than 100 s⁻¹.

37. The method of claim 27, providing a coating temperature is between at least 50° C. and not more than 250° C.

38. The method of claim 37, wherein for coating it done with a counter-roll at a temperature of at least 30° C.

39. The method of claim 27, further comprising the step of, for the purpose of further anisotropy reduction, the PSA deposited on a transport medium, heating to a temperature of at least 60° C.

40. The method of claim 27, wherein adhesive supply systems used are those which, either individually or in combination, effect, on demand, sufficient softening or heating and conveying of preferably solvent-free hot-melt PSAs, preferably drum melting systems, premelters and/or extruders, coupled, where appropriate, with melt pumps.

41. The method of claim 27, wherein as applicator mechanism a coating unit is used which, as a contactless process, forms a melt web.

42. The method of claim 27, wherein deposition elements used are roller elements which are suitable for guiding a product web, capable for a placement to be situated at each surface point of an individual cylindrical element and the free PSA film being placed directly onto a carrier material.

43. The method of claim 27, wherein, after the PSA film has been placed on the deposition medium, it is dried.

44. The method of claim 27, wherein the coating step is followed by crosslinking of the PSA, the crosslinking taking place at least 1 s after the exit of the PSA film from the applicator mechanism.

45. The method of claim 27, wherein under the operating conditions, on exit from the applicator mechanism, the PSAs constitute normewtonian fluids having a structurally viscous character.

46. The method of claim 27, wherein the PSA is of linear, branched, grafted and is a homopolymer, random copolymer or block copolymer, having a molar mass of at least 100 000 g/mol.

47. The method of claim 27, wherein the PSA is based on acrylate copolymers, natural rubbers, synthetic rubbers of ethylene-vinyl acetate copolymers or mixtures thereof.

48. The method of claim 27, wherein the PSA comprises further constituents such as resins, plasticizers, additives with rheological activity, catalysts, initiators, stabilizers, compatibilizers, coupling reagents, crosslinkers, antioxidants, other aging inhibitors, light stabilizers, flame retardants, pigments, dyes, fillers and/or expandants.

49. A pressure-sensitively adhesive product comprising at least one layer based on PSAs produced in accordance with claim 27.

50. A method of controlling the anisotropy in pressure-sensitive adhesives (PSAs) during production, comprising the steps of
providing as operating elements an adhesive supply system, an applicator mechanism, and a deposition element,
forming between the exit of the applicator mechanism and point of placement on the deposition element, a free melt web of the PSA, which undergoes a draw operation, wherein the drawing of the PSA in the free melt web is controlled via an activity ratio F which is characterized as the ratio of activity time Δt in the draw operation to the draw rate R, the activity time Δt being defined by the formula 2 Lr/[v_{web}(1+r)], in which L is the length of the melt web, r is the draw ratio, and v_{web} is the velocity of the melt web, and the draw rate R is defined as the time derivation of the draw ratio r.

51. The method of claim 50, wherein the length of the free melt web is used as control variable.

52. The method of claim 49, wherein, in order to avoid anisotropy in PSAs, a low draw ratio of the free melt web is used as control variable.

53. The method of claim 30, wherein the draw ratio r is not more than 2:1.

54. The method of claim 30, wherein the draw ratio r is not more than 1.5:1.

55. The method of claim 30, wherein the draw ratio is set by reducing the height D of the exit slot to the layer thickness d of the PSA deposited on the deposition element.

56. The method of claim 55, wherein the height D of the adhesive exit slot is not more than 150 μm.

57. The method of claim 55, wherein the height D of the adhesive exit slot is not more than 115 μm.

58. The method of claim 33, wherein the chosen layer thickness d is between 5 μm and 1000 μm.

59. The method of claim 34, wherein for the PSA in the melt web the ratio F is realized such that the length of the melt web is between at least 30 mm and not more than 60 mm.

60. The method of claim 59, wherein for the PSA in the melt web the ratio F is realized such that the length of the melt web is between at least 35 mm and not more than 50 mm.

61. The method of claim 35, wherein the activity time Δt has a value of not more than 0.5 s.

62. The method of claim 36, wherein the PSA in the melt web is subjected to a draw rate R of not more than 50 s⁻¹.

63. The method of claim 36, wherein the PSA in the melt web is subjected to a draw rate R of not more than 10 s⁻¹.

64. The method of claim 37, wherein the coating temperature is between at least 75° C. and not more than 200° C.

65. The method of claim 38, wherein the counter roller has a temperature of at least 60° C.

66. The method of claim 39, wherein the heating is done using a thermal tunnel disposed between the exit from the adhesive applicator mechanism and the entrance to an employable crosslinking station.

67. The method of claim 39, wherein the heating is done to a temperature of at least 90° C.

68. The method of claim 40, wherein the PSAs are solvent-free hot-melt PSAs.

69. The method of claim 40, wherein the PSAs are drum melting systems.

70. The method of claim 40, wherein the PSAs are premelters and/or extruders, coupled with melt pumps.

71. The method of claim 41, wherein one of a slot dies, extrusion die, curtain-coating die and casting die is used.

72. The method of claim 42, wherein deposition elements used are preferably roller elements which are suitable for guiding a product web, and wherein each surface point of an individual cylindrical element is disposed between in the nip between two roll elements, and the free PSA film being placed directly onto a carrier material.

73. The method of claim 42, wherein deposition elements used are preferably roller elements which are suitable for guiding a product web, capable for a placement to be situated at each surface point of an individual cylindrical element or in the nip between two roll elements, and the free PSA film being transferred to a suitable antiadhesive surface as transport medium and then transferred to a product-forming carrier material or liner material.

74. The method of claim 43, wherein, after the drying is performed in a drying tunnel.

75. The method of claim 44, wherein the crosslinking takes place at least 5 s after the exit of the PSA film from the applicator mechanism.

76. The method of claim 44, wherein the crosslinking takes place at least 15 s after the exit of the PSA film from the applicator mechanism.

77. The method of claim 44, wherein the crosslinking takes place preferably by means of UV radiation, electron beams and/or thermal energy.

78. The method of claim 46, wherein the PSA has a molar mass of at least 250 000 g/mol.

79. The method of claim 46, wherein the PSA has a molar mass of at least 500 000 g/mol.

80. The method of claim 46, wherein the PSA has a softening temperature of not more than 20° C.

81. The method of claim 27, wherein the PSA further comprises as a constituent a solvent.

82. The method of claim 30, wherein the draw ratio is set by reducing the height D of the exit slot to the layer thickness d of the PSA deposited on the deposition element.
